(19) United States
(12) Patent Application Publication
(10) Pub. No.: US 2008/0106197 A1
(43) Pub. Date: May 8, 2008

(54) Plasma display device

(76) Inventor: Jung-Suk Song, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/804,658

(22) Filed: May 18, 2007

(30) Foreign Application Priority Data
Nov. 8, 2006 (KR) 10-2006-0109966

(51) Int. Cl. H01J 17/49

(52) U.S. Cl. 313/582

(57) ABSTRACT

A plasma display device is provided. The plasma display device includes: a front substrate; a rear substrate which is spaced apart from the front substrate to face the front substrate; address electrodes which extend on the rear substrate in a first direction; barrier ribs which are disposed between the front and rear substrates to define discharge cells and form spaces between neighboring discharge cells between neighboring discharge cells; bridge barrier ribs which are disposed in the spaces between neighboring discharge cells and connected to the barrier ribs; and first electrodes which extend on the front substrate in a second direction that crosses the first direction, wherein the first electrodes includes: linear portions; and protrusions which are connected to the linear portions and spaced apart from the spaces between neighboring discharge cells. Accordingly, since an interval between neighboring electrodes corresponding to non-discharge regions is large, a mis-discharge is prevented from occurring. It is possible to improve the display performance of the plasma display device.

### CROSS-REFERENCE TO RELATED APPLICATION

This application claims priority to and the benefit of Korean Patent Application No. 10-2006-0109966 filed on Nov. 8, 2006, in the Korean Intellectual Property Office, the entire content of which is incorporated herein by reference.

### BACKGROUND OF THE INVENTION

1. Field of the Invention

The present embodiments relate to a plasma display device, more particularly, to a plasma display device capable of improving an electrode structure.

2. Description of the Related Art

A plasma display device is generally constructed with front and rear substrates. Sustain and scan electrodes for a sustain discharge are formed on the front substrate in parallel with each other. Bus electrodes that are mainly made of silver (Ag) are formed on edges of the sustain and scan electrodes. The bus electrodes are made of silver to compensate for the high resistance of transparent electrodes that are made of indium tin oxide (ITO). Address electrodes are arranged on the rear substrate that faces the front substrate in a direction that crosses the sustain and scan electrodes. The address electrodes are coated with a dielectric layer. Barrier ribs are formed on the dielectric layer.

The barrier ribs may be formed in various shapes. For example, exhaust paths are formed in a direction that crosses the length direction of the address electrodes, and bridge barrier ribs are formed in the exhaust paths. When the barrier rib structure is coated with a phosphor material by using a dispenser technique, the bridge barrier ribs and the exhaust paths are coated with the phosphor material. This is because coating does not stop during the coating process due to a characteristic of the dispenser technique.

When a discharge sustain voltage is applied to the sustain and scan electrodes, a sustain discharge occurs in the discharge cells and wall charges are generated. Although a discharge does not have to occur in the exhaust paths, the discharge frequently occurs in the exhaust paths when bus electrodes of a discharge cell are close to bus electrodes of a neighboring discharge cell. That is, in an existing technique, there is a problem that a mis-discharge easily occurs in the exhaust paths that are non-discharge regions.

In addition, when the exhaust paths that are the non-discharge regions and the bridge barrier ribs are coated with the phosphor material, and the mis-discharge occurs in the non-discharge regions, vacuum ultraviolet rays collide against the phosphor material to generate visible light. The generated visible light interrupts the display of suitable images and deteriorates the display performance of the plasma display device.

### SUMMARY OF THE INVENTION

According to an aspect of the present embodiments, there is provided a plasma display device comprising: a front substrate; a rear substrate which is spaced apart from the front substrate to face the front substrate; address electrodes which extend on the rear substrate in a first direction; barrier ribs which are disposed between the front and rear substrates to define discharge cells and form spaces between neighboring discharge cells between neighboring discharge cells; bridge barrier ribs which are disposed in the spaces between neighboring discharge cells and connected to the barrier ribs; and first electrodes which extend on the front substrate in a second direction that crosses the first direction, wherein the first electrodes includes: linear portions; and protrusions which are connected to the linear portions and spaced apart from the spaces between neighboring discharge cells. Here, the first electrodes may include bus electrodes.

In the above aspect of the present embodiments, an interval between the linear portions of the neighboring discharge cells by interposing the exhaust path therebetween may be smaller than an interval between the protrusions of the neighboring discharge cells.

In addition, the linear portions and the protrusions may have the same width.

In addition, the protrusions may have a planar shape of a hollow rectangle with one side opened.

In addition, second electrodes, which are connected to the linear portions and formed so as to protrude toward the centers of the discharge cells, may be additionally formed.

In addition, the second electrodes may have a planar shape of a rectangle.

In addition, the second electrodes may include: first portions of which one sides are connected to the linear portions; and second portions which are formed on the other sides of the first portions so as to have a shape of crossing the first portions.

In addition, the barrier ribs may include: longitudinal barrier ribs which extend in the first direction to be spaced apart from one another in the second direction; and transverse barrier ribs which extend in the first direction to be spaced apart from one another in the first direction.

In addition, the spaces between neighboring discharge cells may be formed between neighboring discharge cells in the first direction.

In addition, the transverse barrier ribs may be connected to one another through the bridge barrier ribs. In addition, the bridge barrier ribs may be formed on a central axis that connects neighboring discharge cells in the first direction. In addition, the width of the bridge barrier ribs measured in the second direction may be the same as the length of the linear portions measured in the second direction.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a perspective view schematically illustrating a plasma display device according to a first embodiment by an exploded view of the plasma display device;

FIG. 2 is a cross sectional view taken along line II-II of FIG. 1;

FIG. 3 is a top plan view illustrating an arrangement of discharge cells and electrodes of FIGS. 1 and 2;

FIG. 4 is a top plan view illustrating an arrangement of discharge cells and electrodes of a plasma display device according to a second embodiment; and

FIG. 5 is a top plan view illustrating a plasma display device according to a third embodiment.

### DETAILED DESCRIPTION OF THE PREFERRED EMBODIMENTS

The present embodiments will now be described more fully hereinafter with reference to the accompanying drawings, in which preferred embodiments are shown. As those skilled in the art would realize, the described embodiments may be modified in various different ways, all without departing from the spirit or scope of the present embodiments. To clearly describe an embodiment, parts not related to the description are omitted. Like reference numerals designate like elements throughout the specification.

A plasma display device according to an embodiment will be described on the basis of an AC surface discharge type plasma display device. However, the present embodiments may be applied to other types of plasma display devices.

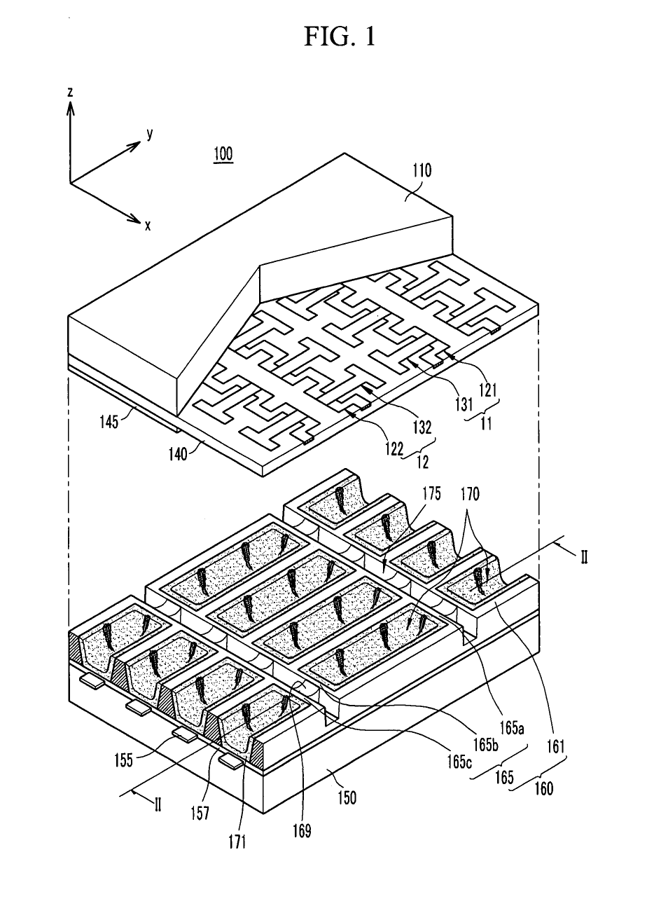

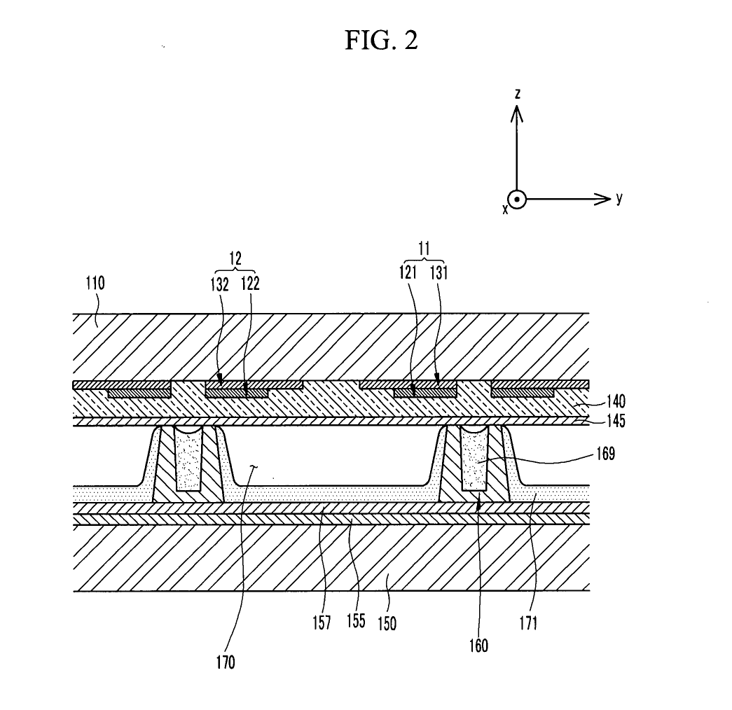

FIG. 1 is a perspective view schematically illustrating a plasma display device according to a first embodiment by an exploded view of the plasma display device. FIG. 2 is a cross sectional view taken along line II-II of FIG. 1.

Referring to FIGS. 1 and 2, a plasma display device 100 according to the first embodiment includes front and rear substrates 110 and 150. Various electrodes 11, 12 and 155 and dielectric layers 140 and 157 are formed on inner surfaces of the front and rear substrates 110 and 150. Barrier ribs 160 are disposed between the front and rear substrates 110 and 150. The barrier ribs 160 are formed with a predetermined height between the rear and front substrates 150 and 110 to define discharge cells 170. Each discharge cell 170 is filled with a discharge gas (for example, a mixture gas including neon (Ne) and xenon (Xe)) so as to generate vacuum ultraviolet rays through a gas discharge. Phosphor layers 171 which emit visible light by absorbing the vacuum ultraviolet rays are formed in the discharge cells 170.

Address electrodes extend in a first direction (y-axis direction of FIGS. 1 and 2) on the rear substrate 150. The address electrodes 155 have a function of selecting discharge cells in which a discharge is to be carried out by applying an address pulse. Since the address electrodes 155 are disposed on the rear substrate 155, the address electrodes 155 do not block visible light which is irradiated onto the front side. Accordingly, the address electrodes 155 may be made of an opaque material. The address electrodes 155 may be made of a metal having a high conductivity.

The rear substrate 150 and the address electrodes 155 are coated with a first dielectric layer 157. The first dielectric layer 157 prevents positive ions or electrons from directly colliding against the address electrodes 155 when a discharge is carried out. In addition, the first dielectric layer 157 generates wall charges. The wall charges are accumulated in the first dielectric layer 157. Thus, a memory characteristic that is one of the main characteristics of the AC plasma display device 100 is represented.

Display electrodes, which are sustain and scan electrodes 11 and 12, are formed in a second direction (x-axis direction of FIGS. 1 and 2) that crosses the first direction in parallel with one another. The sustain electrodes 11 include bus electrodes 121 and extended electrodes 131 which extend from the bus electrodes 121. The scan electrodes 12 include bus electrodes 122 and extended electrodes 132 which extend from the bus electrodes 122.

The extended electrodes 131 and 132 are portions where a surface discharge is carried out in the discharge cells 170. The extended electrodes 131 and 132 are typically made of a transparent material, for example, ITO so as to secure an aperture ratio of the discharge cells 170. The bus electrodes 121 and 122, which are made of a metal having a high conductivity so as to compensate for high electric resistance of the extended electrodes 131 and 132, are formed at edges of the discharge cells 170.

The front substrate 110 and the sustain and scan electrodes 11 and 12 on the inner surface of the front substrate 110 are coated with a second dielectric layer 140. The second dielectric layer 140 prevents positive ions or electrons from directly colliding against the sustain and scan electrodes 11 and 12, when the discharge is carried out. In addition, like the first dielectric layer 157, the second dielectric layer 140 generates wall charges. The wall charges are accumulated in the second dielectric layer 140.

A protective layer 145 made of a material such as, for example, magnesium oxide (MgO) is deposited on the second dielectric layer 140. The protective layer 145 protects the second dielectric layer 140 against sputtering of ions. Since the protective layer 145 has a relatively high secondary electron emission coefficient when low energy ions collide against the surface of the protective layer 145 during the discharge, the protective layer 145 reduces driving and sustain voltages of discharge plasma.

Barrier ribs 160 are disposed on the first dielectric layer 157 to secure a predetermined space between the front and rear substrates 110 and 150. In addition, the barrier ribs 160 define the discharge cells in the first direction to form spaces between neighboring discharge cells 175 between neighboring discharge cells 170 in the second direction.

The spaces between neighboring discharge cells 175 are used as paths through which a gas moves when a remaining gas is extracted and a discharge gas is injected after a sealing process of the front and rear substrates 110 and 150 of the plasma display device 100 is performed. The spaces between neighboring discharge cells 175 may be formed in the first and second directions. In the first embodiment, the spaces between neighboring discharge cells 175 are formed in the second direction so as to minimize an area decrease of the discharge cells 170.

The barrier ribs 160 include longitudinal barrier ribs 161 and transverse barrier ribs 165. The longitudinal barrier ribs 161 extend in the first direction to be spaced apart from one another in the second direction. The transverse barrier ribs 165 extend in the second direction to be spaced apart from one another in the first direction.

In addition, first and second transverse barrier ribs 165a and 165b which face each other in the first direction among transverse barrier ribs 165 determines a first direction length of each discharge cell 170.

The second transverse barrier rib 165b and a third transverse barrier rib 165c are spaced apart from each other to determine a width of each space between neighboring discharge cells 175.

Bridge barrier ribs 169 are formed between the second and third transverse barrier ribs 165b and 165c, that is, on the central axis that connects neighboring discharge cells 170 in the first direction in the spaces between neighboring discharge cells 175. The second and third transverse barrier ribs 165b and 165c are connected with each other through the bridge barrier ribs 169.

A reflective layer (not shown) may be formed in the discharge cells 170 that are defined by the barrier ribs 160. The reflective layer may be a white oxide. For example, the white oxide may be formed by including titanium dioxide (TiO₂) or aluminum oxide (Al₂O₃) or including a mixture of titanium dioxide (TiO₂) and aluminum oxide (Al₂O₃).

A phosphor layer 171 is formed on the reflective layer by using a dispenser technique. The discharge cells 170 arranged in the first direction are coated with the same color phosphor material. The discharge cells 170 arranged in the second direction are coated with phosphor materials of red, green, and blue, respectively. Three discharge cells 170 corresponding to red, green, and blue together form a pixel.

The discharge cells 170 of the plasma display device 100 are filled with a discharge gas to a a pressure of from about 300 to about 500 Torr. A penning mixture gas can be used as the discharge gas. For example, xenon (Xe), which allows the phosphor layer 171 to emit light and emits vacuum ultraviolet rays, can be mixed into a buffer gas formed by using helium (He), neon (Ne), argon (Ar), or a gas mixture thereof and used.

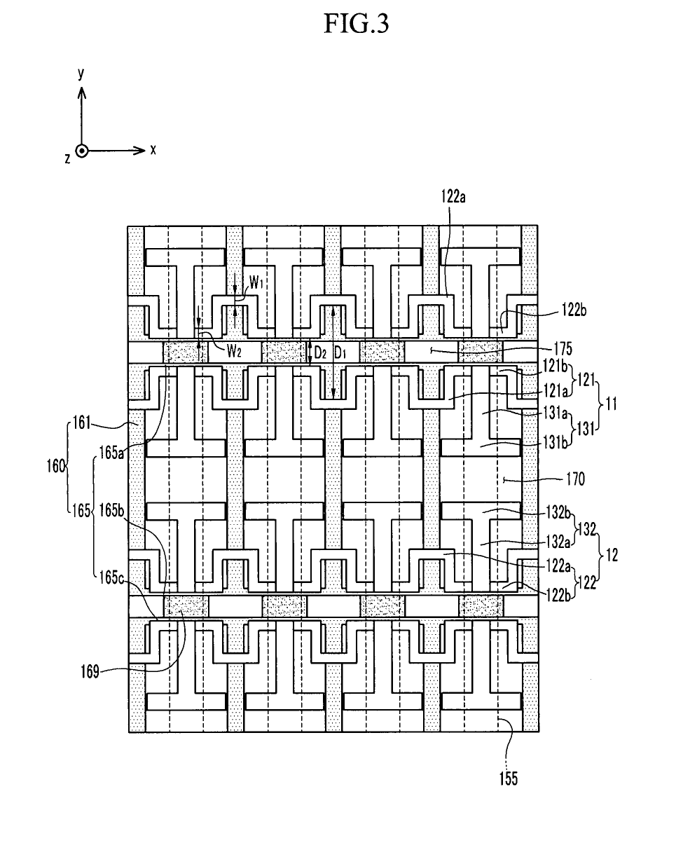

FIG. 3 is a top plan view illustrating an arrangement of the discharge cells 170 and the electrodes 11, 12, and 155 of FIGS. 1 and 2.

Referring to FIG. 3, the sustain electrodes 11 include the bus electrodes 121 and the extended electrodes 131. The scan electrodes 12 include the bus electrodes 122 and the extended electrodes 132.

The extended electrodes 131 of the sustain electrodes 11 are formed in parallel with one another in the second direction. The extended electrodes 132 of the scan electrodes 12 are formed in parallel with one another in the second direction. A pair of extended electrodes 131 and 132 are disposed above a single discharge cell 170. The pair of extended electrodes 131 and 132 include first portions 131a and 132a which protrude toward the center of the discharge cell 170 and second portions 131b and 132b which are connected to ends of the first portions 131a and 132a and orthogonal to the first portions 131a and 132a. That is, a pair of sustain and scan electrodes 11 and 12 are formed above a single discharge cell 170 in a T shape so that the second portions 131b and 132b face each other.

The bus electrodes 121 and 122 of the sustain and scan electrodes 11 and 12 are disposed at edges of the discharge cells 170 and connected to the first portions 13 la and 132a of the extended electrodes 131 and 132. The bus electrodes 121 and 122 extend in the second direction. The bus electrodes 121 and 122 are made of a metal having a high conductivity so as to compensate for high electric resistance of the extended electrodes 131 and 132.

The bus electrodes 121 and 122 include protrusions 121a and 122a and linear portions 121b and 122b.

The protrusions 121a and 122a are connected to the linear portions 121b and 122b and disposed corresponding to the spaces between neighboring discharge cells 175 that are disposed between neighboring bridge barrier ribs 169. Two protrusions 121a and 122a disposed at both edges of a discharge cell 170 protrude to face each other. That is, the two protrusions 121a and 122a protrudes face each other over the longitudinal barrier ribs 161 disposed between the neighboring discharge cells 170 in the second direction.

Accordingly, an interval D1 between the protrusions 121a and 122a of neighboring bus electrodes 121 and 122 among bus electrodes 121 and 122 disposed over neighboring discharge cells 170 in the first direction is greater than an interval D2 between the linear portions 121b and 122b of the neighboring bus electrodes 121 and 122. In this embodiment, a width W₁ of the protrusions 121a and 122a is the same as that of the linear portions 121b and 122b. However, the present embodiments are not limited thereto. The protrusions 121a and 122a and the linear portions 121b and 122b may have various widths.

When the interval D1 between the protrusions 121a and 122a of the bus electrodes 121 and 122 is greater than the interval D2 between the linear portions 121b and 122b, a mis-discharge is prevented from occurring in the spaces between neighboring discharge cells 175 which are non-discharge regions.

In addition, since the mis-discharge does not occur in the non-discharge regions, the display performance of the plasma display device 100 (see FIG. 1) can also be prevented from deteriorating due to the phosphor material coated on the spaces between neighboring discharge cells 175 and the bridge barrier ribs 169.

A light emitting mechanism of the plasma display device 100 will now be described. First, when address and scan voltages are respectively applied to the address and scan electrodes, an address discharge occurs. Wall charges are generated in the discharge cells 170. Next, when a discharge sustain voltage is applied between the scan and sustain electrodes 12 and 11, the applied discharge sustain voltage is added to a wall voltage that is formed by the wall charges to exceed a firing voltage. A sustain discharge occurs in the discharge cells 170.

When the aforementioned discharge occurs, vacuum ultraviolet rays having, for example, about 147 nm wavelength collides against the red, green, and blue phosphor layers to generate visible light. Images can be obtained by combining the generated visible light.

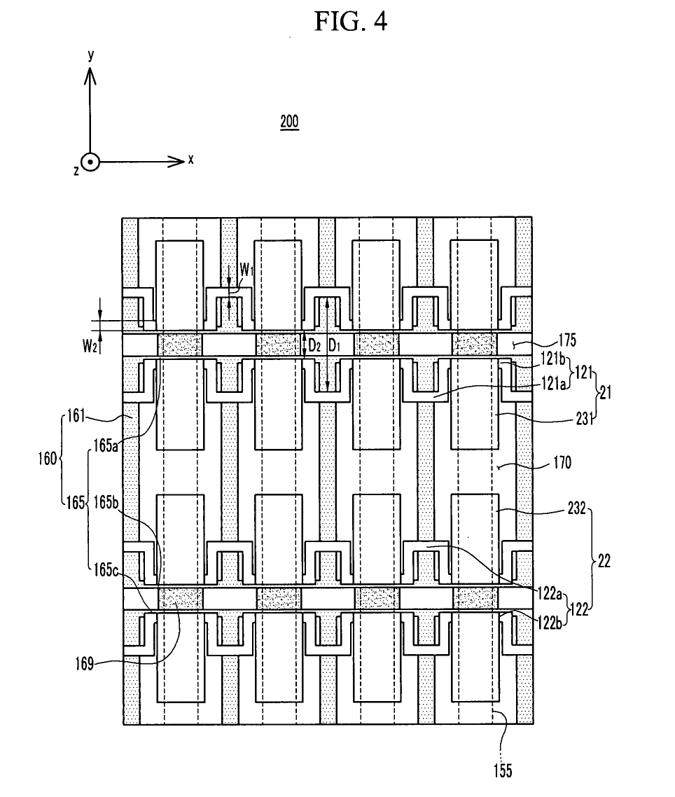

FIG. 4 is a top plan view illustrating an arrangement of discharge cells and electrodes of a plasma display device according to a second embodiment.

Referring to FIG. 4, extended electrodes 231 and 232 of sustain and scan electrodes 21 and 22 are connected to linear portions 121b and 122b of bus electrodes 121 and 122 of the sustain and scan electrodes 21 and 22. The extended electrodes 231 and 232 have a planar shape of a rectangle. Here, reference numerals which are the same as those of the first embodiment represent the same elements.

The bus electrodes 121 and 122 of the sustain and scan electrodes 21 and 22 include protrusions 121a and 122a and linear portions 121b and 122b like the first embodiment. The protrusions 121a and 122a are connected to the linear portions 121b and 122b and disposed corresponding to spaces between neighboring discharge cells 175 that are disposed between neighboring bridge barrier ribs 169. Two protrusions 121a and 122a disposed at both edges of a discharge cell 170 protrude to face each other. That is, the two protrusions 121a and 122a protrude to face each other over the longitudinal barrier ribs 161 disposed between the neighboring discharge cells 170 in the second direction.

Accordingly, an interval D1 between the protrusions 121a and 122a of neighboring bus electrodes 121 and 122 disposed over neighboring discharge cells 170 in the first direction is greater than an interval D₂ between the linear portions 121b and 122b of the neighboring bus electrodes 121 and 122. In this embodiment, a width W₁ of the protrusions 121a and 122a is the same as that of the linear portions 121b and 122b. However, the present embodiments are not limited thereto.

Other elements and operations thereof which are not described in the embodiment do not differ significantly from those of the first embodiment.

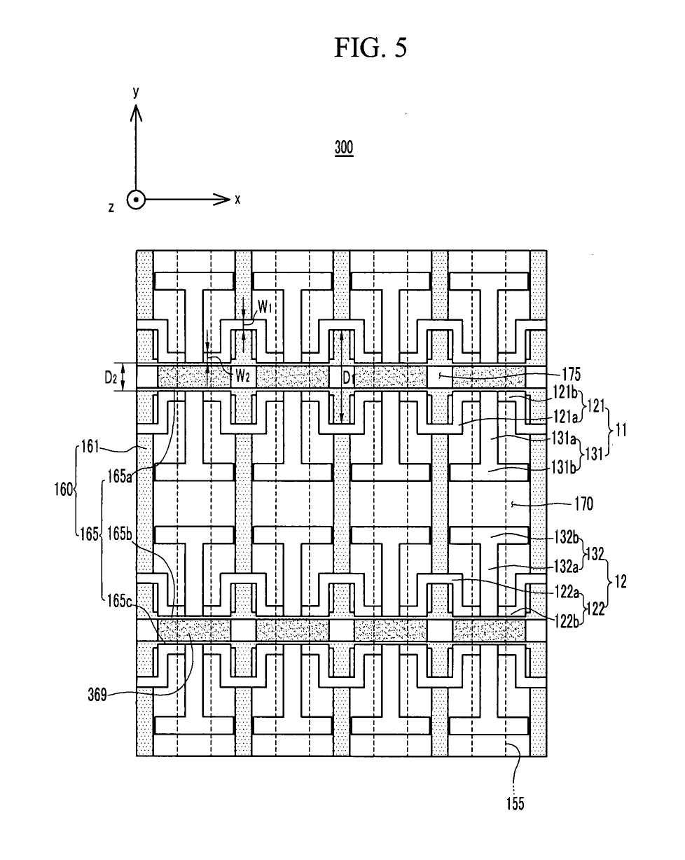

FIG. 5 is a top plan view illustrating a plasma display device according to a third embodiment.

Referring to FIG. 5, a width of bridge barrier ribs 369 measured in the second direction may be the same as a length of linear portions 121b and 122b measured in the second direction.

Here, reference numerals which are the same as those of other embodiments represent the same elements. Other elements and operations thereof which are not described in the embodiment do not differ significantly from those of the first embodiment.

While the present embodiments have been described in connection with what is presently considered to be practical exemplary embodiments, it is to be understood that the present embodiments are not limited to the disclosed embodiments, but, on the contrary, are intended to cover various modifications and equivalent arrangements included within the spirit and scope of the appended claims.

What is claimed is:

1. A plasma display device comprising:
a front substrate;
a rear substrate which is spaced apart from the front substrate and faces the front substrate;
address electrodes which extend along the rear substrate in a first direction;
barrier ribs which are disposed between the front and rear substrates and are configured to define discharge cells and are configured to form a space between neighboring discharge cells;
bridge barrier ribs which are disposed in the space between neighboring discharge cells and are connected to the barrier ribs; and
first electrodes which extend along the front substrate in a second direction that crosses the first direction,
wherein the first electrodes comprise:
linear portions; and
protrusions which are connected to the linear portions and disposed apart from the space between neighboring discharge cells.

2. The plasma display device of claim 1, wherein an interval between the linear portions of neighboring discharge cells made by interposing the space between neighboring discharge cells therebetween is smaller than an interval between the protrusions of the neighboring discharge cells.

3. The plasma display device of claim 1, wherein the linear portions and the protrusions have substantially the same width.

4. The plasma display device of claim 2, wherein the protrusions have a planar shape of a hollow rectangle with one side opened.

5. The plasma display device of claim 2, further comprising second electrodes which are connected to the linear portions and formed so as to protrude toward the centers of the discharge cells.

6. The plasma display device of claim 5, wherein the second electrodes have a planar shape of a rectangle.

7. The plasma display device of claim 5, wherein the second electrodes comprise:
first portions of which one side is connected to the linear portions; and
second portions which are formed on the other sides of the first portions so as to have a shape of crossing the first portions.

8. The plasma display device of claim 1, wherein the barrier ribs comprise:
longitudinal barrier ribs which extend in the first direction and are spaced apart from one another in the second direction; and
transverse barrier ribs which extend in the second direction and are spaced apart from one another in the first direction.

9. The plasma display device of claim 8, wherein the spaces between neighboring discharge cells are formed in the second direction.

10. The plasma display device of claim 9, wherein the transverse barrier ribs are connected to one another through the bridge barrier ribs.

11. The plasma display device of claim 10, wherein the bridge barrier ribs are formed on a central axis that connects neighboring discharge cells in the first direction.

12. The plasma display device of claim 10, wherein the width of the bridge barrier ribs measured in the second direction is substantially the same as the length of the linear portions measured in the second direction.

13. The plasma display device of claim 1, wherein the first electrodes include bus electrodes.

14. The plasma display device of claim 1, wherein the discharge cells are filled with a penning mixture gas.

15. The plasma display device of claim 1, wherein the discharge cells are filled with at least one of helium (He), neon (Ne), argon (Ar) or a mixture thereof.

16. The plasma display device of claim 1, further comprising a reflective layer formed in the discharge cells.

17. The plasma display device of claim 16, wherein the reflective layer comprises at least one of titanium dioxide (TiO₂), aluminum oxide (Al₂O₃) and a mixture of titanium dioxide (TiO₂) and aluminum oxide (Al₂O₃).

18. The plasma display device of claim 1, further comprising a protective layer.

19. The plasma display device of claim 18, wherein the protective layer comprises magnesium oxide (MgO).

20. The plasma display device of claim 1, wherein the space between neighboring discharge cells comprises phosphor material.
